(19) United States
(12) Patent Application Publication
(10) Pub. No.: US 2014/0237824 A1
(43) Pub. Date: Aug. 28, 2014

(54) Egg Shell-Piercing Device

(71) Applicant: Dave Denton, Momence, IL (US)

(72) Inventor: Dave Denton, Momence, IL (US)

(21) Appl. No.: 14/187,957

(22) Filed: Feb. 24, 2014

Related U.S. Application Data
(60) Provisional application No. 61/769,817, filed on Feb. 27, 2013.

(51) Int. Cl. A47J 43/14

(52) U.S. Cl. CPC A47J 43/14
USPC 30/120.1

(57) ABSTRACT

An egg shell-piercing device pierces an egg shell and includes a combination skirt-handle construction and a pointed, shell-piercing member. The skirt-handle construction includes a skirt portion and a handle portion. The skirt portion has an inner concave surface for receiving a convex contour of an egg shell. The inner concave surface has an inner surface depth and a threaded female structure. The shell-piercing member has a pointed end and a threaded end. The threaded end is threadably connected to the skirt-handle construction via the threaded female structure and includes a shell-piercing length. The inner surface depth is greater than the shell-piercing length. The inner concave surface receives a select egg shell and the shell-piercing member pierces the select egg shell as it is received.

### PRIOR HISTORY

This non-provisional patent application claims the benefit of pending U.S. Provisional Patent Application No. 61/769,817 filed in the United States Patent and Trademark Office on 27 Feb. 2014.

### BACKGROUND OF THE INVENTION

1. Field of the Invention

The present invention generally relates to an egg shell-piercing device or apparatus for piercing a hole in a shell of an egg. More particularly, the present invention relates to an egg shell-piercing device or apparatus for piercing a hole in a shell of an egg to be hard-boiled to facilitate removal of the shell once it has become hard-boiled.

2. Brief Description of the Prior Art

As noted by inventor Cabello in U.S. Pat. No. 6,276,265, when hard boiled eggs are prepared, and the shells are removed therefrom for further processing of the hard-boiled contents, the removal of the shell from the egg can often be quite difficult. An effective method of facilitating egg shell removal involves the process of piercing the egg shell veil with a small hole before they are hard-boiled. The hole in the shell does not interfere with the process of boiling the egg. However, the small hole does permit the water entry into the egg compartment for forming a layer between the inner surface of the egg shell and the outer surface of the edible portion of the egg. Consequently, when the egg has been hard boiled and the egg has been removed from the boiling water, the shell of the egg readily peels away from the white of the egg so that the white of the egg and the yolk therein are not broken or otherwise damaged during such shell peeling operation.

Accordingly, egg poker devices have been devised for poking a small hole in the shell of an egg prior to boiling the same. Some of the more pertinent art relating to egg shell piercing or processing devices are briefly described hereinafter. U.S. Pat. No. 1,491,908 ('908 Patent), which issued to Greig for example, discloses a Device for Cutting Off or Facilitating the Removal of the Tops of Eggshells. The '908 Patent describes a device having a circular cutting member which consists of a band or ring of tempered steel or the like having saw like cutting teeth at one edge. These teeth are inwardly and preferably downwardly directed and the band is suitably secured to the inside of the casing or holder formed with a manipulating flange constituting a hand grip. The end of the casing with the flange is closed and carries a projecting pin or point, the latter of which functions to pierce the outer shell of an egg as depicted in FIG. 1-3.

U.S. Pat. No. 2,445,490 ('490 Patent), which issued to Meade, discloses an Automatic Suction Means for Removing Egg Liquid. The '490 Patent describes a device that functions to pierce or puncture the outer shell of egg (via element 19) through the shell at two opposite points and simultaneously applying vacuum suction at one puncture so as to cause the liquid content of said egg to discharge the area under compulsion of atmospheric pressure applied at the other puncture.

U.S. Pat. No. 3,270,661 ('661 Patent), which issued to Juvan, discloses an Egg Cooking Device. The '661 Patent describes a housing which is bored at one end to form a cup within which is a disc type temperature gauge is slidable between the rim of the cup and the base thereof. The gauge has a dial and indicating needle on the upper side thereof.

A pointed prong (as at element 21) is affixed to the rear side of the gauge and extends through a central opening in the housing and central opening aligned therewith in the metal cylinder. The opening is counterbored at is upper portion as shown to contain a compression coil spring at the lower end which bears against a disc rigidly secured to the prong. The upper end bears against a collar fitted into the upper end of the counterbore and secured therein by a set screw.

U.S. Pat. No. 3,411,432 ('432 Patent), which issued to Willett, discloses a Weiner and Egg Steamer. The '432 Patent describes an egg piercing unit supported slidably moveable within an H-configured slot extending through the cover. The unit includes a hemispherical inverted cup which fits over the upper end of an egg. A vertical opening in the cup receives a downwardly pointed pin (as at element 45), the upper end of which extends out of the housing and is topped by a knob for manual adjustment.

A flange integral with a midportion of the pin bears against the upper end of a coil spring, the lower end of which bears against the cup. Raised ridges having a groove between provide means for indicating when the unit is in a position over one of the eggs supported in the openings as at 33, thereby aligning the pointed (shell-piercing) pin with the egg.

U.S. Pat. No. 3,855,915 ('915 Patent,), which issued to Hoyt et al., discloses an Egg Blowing Device. The '915 Patent describes an egg blowing device consisting of a hollow body member one wall of which constitutes a flexible diaphragm adapted to be pressed against an egg, the diaphragm having a hole therein adapted to overlies a hole formed in the shell of the egg, a shell piercing spike fixed in the body member and projecting outwardly through the hole of the diaphragm, and an air pump for introducing air under pressure into the body member.

U.S. Pat. No. 4,019,430 ('430 Patent), which issued to Warren, discloses a Vacuum Egg Lifting and Penetrating Means. The '430 Patent discloses a method and apparatus whereby eggs are punctured via element 16, which eggs are then transfer to a heating medium, such as a boiler. The expansion of the egg contents generates no shell splitting forces as the egg contents expand into the natural egg air cell space during an escape of air through the shell puncture. The escape of air from the egg shell reduces the tendency of the eggs to float in the cooker water and also permits the eggs to expand to a desirable rounded shape.

U.S. Pat. No. 6,276,265 ('265 Patent), which issued to Cabello, discloses an Egg Poker Device. The '495 Patent discloses an egg poker device is disclosed for piercing a hole in a shell of an egg to be boiled to facilitate removal of the shell. The device includes a first member having a base and a wall extending away from the base such that the base and the wall define therebetween a cavity.

A disc shaped spring is disposed within the cavity and adjacent to the base, the spring having a central portion. The spring also defines a peripheral edge. The first end of a rod is secured to the central portion of the spring and a second end of the rod defines a point for piercing the hole in the shell of the egg. A second member slidably cooperates with the first member. The second member includes a support for supporting the egg, the support defining a hole for the slidable passage therethrough of the point of the rod. A skirt portion extends from the support such that the skirt portion slidably cooperates with the wall.

Included in the prior art is an egg poker device which has an egg supporting surface thereon. A central hole is provided for the passage therethrough of a needle. A first member slidably receives therein the supporting surface. The supporting surface includes a depending skirt portion which cooperates with an annular wall of the first member. When the egg is supported on the surface and the egg and supporting surface are pressed downwardly, the point of the needle pierces the shell of the egg. However, the aforementioned prior art egg poker is relatively complex in construction and requires the provision of a compression spring for urging the support away from the first member.

From a review of the foregoing citations in particular, and from a consideration of the prior art in general, it will be seen that the prior art thus perceives a need for an egg shell-piercing device or apparatus of simplified, low cost construction. In other words, the egg shell-piercing device or apparatus of the present invention overcomes the problems associated with the prior art device and provides an egg poker of extremely simple construction which greatly reduces the cost of manufacture thereof.

Therefore, it is a primary feature of the present invention to provide an egg shell-piercing device or apparatus that overcomes the aforementioned disadvantages of the prior art devices. Another feature of the present invention is the provision of an egg shell-piercing device or apparatus that is extremely easy to construct. A further feature of the present invention is the provision of an egg shell-piercing device or apparatus that is simple to operate and of relatively low cost compared with the prior art arrangements.

Other features and advantages of the present invention will be readily apparent to those skilled in the art by a consideration of the summary of the invention as set forth hereinafter.

### SUMMARY OF THE INVENTION

The present invention provides an egg shell-piercing device that basically functions to pierce an egg shell for forming a hole therein. To achieve this primary function, the egg shell-piercing device according to the present invention preferably comprises a combination skirt-handle construction and a pointed, shell-piercing member.

The combination skirt-handle construction preferably comprises a lower skirt construction and an upper handle construction or portion. The skirt and handle constructions are preferably integrally formed. In this regard, it is contemplated that the preferred material construction for the combination skirt-handle construction is of a molded polymeric material for reducing manufacturing costs for the device and enabling the manufacturer to provide such a combination skirt-handle construction in a variety of colors.

The skirt construction is essentially bowl-shaped or dish-shaped and thus preferably comprises an inner concave surface and an outer convex surface. The inner concave surface basically functions as a receiving surface for receiving an outer convex (shell) contour of an egg.

The pointed, shell-piercing member preferably comprises a lower pointed end and an upper threaded end. The upper threaded end is threadably connected to or otherwise cooperably associated with the combination skirt-handle construction via a threaded female structure formed in the skirt construction. The shell-piercing member is preferably formed from a rigid, metallic material for enhancing its durability.

The skirt construction preferably joins the handle construction by way of a skirt-to-handle junction construction, which skirt-to-handle junction construction comprises a disk-shaped exterior construction and a concave inner construction. The concave inner construction is coextensive with the inner concave surface in radial adjacency to the threaded female structure. The handle construction is peripherally rectangular in both a first dimension and a second dimension. In the third dimension, however, the handle construction is peripherally hourglass-shaped.

The hourglass-shaped third dimension of the handle construction preferably comprises a hand-gripping center region and an end region. The hand-gripping center region preferably comprises opposed concave handle surfaces, and the end region preferably comprises a convex end surface. The hourglass-shaped third dimension further preferably comprises a frontal plane, which frontal plane extends intermediate an anterior handle half and a posterior handle half. The anterior and posterior handle halves are non-symmetrical about the frontal plane such that the anterior and posterior handle halves may be structurally distinguished.

The hourglass-shaped third dimension further comprises an egg-shaped aperture for further reducing material cost and providing certain means for hanging the device via an aperture-engaging device. The egg-shaped aperture comprises a major axis and a minor axis. The frontal plane comprises the major axis of the egg-shaped aperture.

The hourglass-shaped third dimension further preferably comprises a recessed material construction in adjacency to the egg-shaped aperture. In this regard, the peripherally rectangular first and second dimensions each preferably comprise an I-shaped transverse cross-section. The recessed material construction helps reduce molding costs; increases or maintains handle strength; and speeds manufacturing times for the combination skirt-handle construction.

Other objects of the present invention, as well as particular features, elements, and advantages thereof, will be elucidated or become apparent from, the following description and the accompanying drawing figures.

### BRIEF DESCRIPTION OF THE DRAWINGS

Other features and objectives of my invention will become more evident from a consideration of the following brief description of patent drawings:

FIG. 1A is a first lateral elevational view of the egg shell-piercing device according to the present invention.

FIG. 1B is a second lateral elevational view of the egg shell-piercing device according to the present invention.

FIG. 1C is a transverse cross-sectional view of the handle construction of the egg shell-piercing device according to the present invention as sectioned from FIG. 1A showing an I-shaped transverse cross-section in a first dimension.

FIG. 1D is a longitudinal cross-sectional view of the handle construction of the egg shell-piercing device according to the present invention as sectioned from FIG. 1B showing an I-shaped longitudinal cross-section in a second dimension.

FIG. 2A is a bottom end plan view of the egg shell-piercing device according to the present invention.

FIG. 2B is a top end plan view of the egg shell-piercing device according to the present invention.

FIG. 3A is a posterior edge view of the egg shell-piercing device according to the present invention.

FIG. 3B is an anterior edge view of the egg shell-piercing device according to the present invention.

FIG. 4A is a top perspective view of the egg shell-piercing device according to the present invention.

FIG. 4B is an exploded bottom perspective view of the egg shell-piercing device according to the present invention.

FIG. 5A is a first sequential depiction of the egg shell-piercing device according to the present invention as otherwise shown in FIG. 1A just prior to receiving a phantom egg shell at the inner concave surface of the skirt construction of the egg-shell piercing device.

FIG. 5B is a second sequential depiction of the egg shell-piercing device according to the present invention as otherwise shown in FIG. 1A as it receives a phantom egg shell at the inner concave surface of the skirt construction, the shell-piercing member of the egg shell-piercing device piercing the phantom shell.

FIG. 5C is a third sequential depiction of the egg shell-piercing device according to the present invention as otherwise shown in FIG. 1A as it is removed from the phantom egg shell, the shell-piercing member of the egg shell-piercing device having pierced the phantom shell and leaving an aperture in the egg shell.

### DETAILED DESCRIPTION OF THE PREFERRED EMBODIMENT

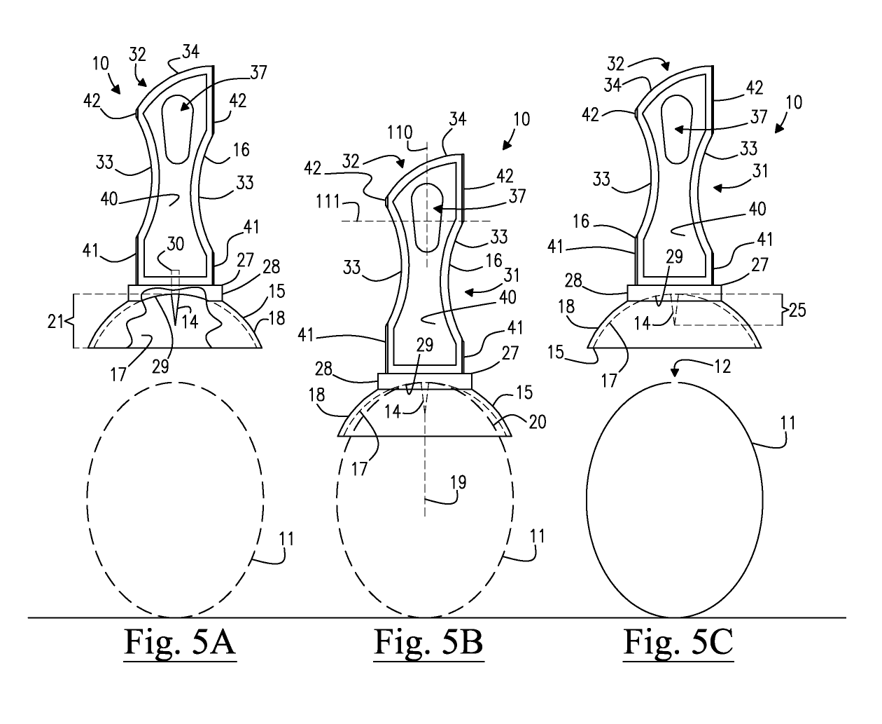

Referring now to the drawings with more specificity, the present invention preferably provides an egg shell-piercing device as at 10, which egg shell-piercing device 10 basically functions to pierce an egg shell as at 11 for forming a hole or aperture as at 12 therein, and as generally and sequentially depicted in FIGS. 5A through 5C. To achieve this primary function, the egg shell-piercing device 10 according to the present invention preferably comprises a combination skirt-handle construction as at 13 and a pointed, shell-piercing member as at 14.

The combination skirt-handle construction 13 preferably comprises a lower skirt construction or portion as at 15, and an upper handle construction or portion as at 16. The skirt and handle constructions 15 and 16 are preferably integrally formed. In this regard, it is contemplated that the preferred material construction for the combination skirt-handle construction 13 is of a molded polymeric material for reducing manufacturing costs for the device 10 and enabling the manufacturer to provide such a combination skirt-handle construction 13 in a variety of colors as perhaps exemplified by the colors of the rainbow.

The skirt construction 15 is essentially bowl-shaped or dish-shaped and thus preferably comprises an inner concave surface as at 17, an outer convex surface as at 18, and a skirt axis as at 19. The inner concave surface 17 basically functions as a receiving surface 17 for receiving an outer convex (shell) contour of an egg as at 20. Referencing FIG. 5A, the reader will please note the inner concave surface 17 preferably further comprises an inner surface depth as at 21.

The pointed, shell-piercing member 14 preferably comprises a lower pointed end 22 and an upper threaded end 23. The upper threaded end 23 is preferably and threadably connected to, or otherwise cooperably associated with (e.g. integrally formed with), the combination skirt-handle construction 13 via a threaded female structure 30 formed in the skirt construction 15, which threaded female structure 30 is coaxial with the skirt axis 19. The shell-piercing member 14 is preferably formed from a rigid, metallic material for enhancing its durability and comprises a member axis as at 24 and a lower (or exposed) shell-piercing length as at 25.

The member axis 25 of the shell-piercing member 14 is coaxial with the skirt axis 19 when the shell-piercing member 14 is threadably connected to the combination skirt-handle construction 13, and the inner surface depth 21 is preferably greater in magnitude than the lower or exposed shell-piercing length 25 of the shell-piercing member 14. Noting that the skirt construction 15 preferably further comprises a planar skirt rim as at 26, the planar skirt rim 26 and the (relatively greater) inner surface depth 21 (and relatively lesser shell-piercing length 25) enable the user to stand the egg shell-piercing device 10 upon a planar support surface as at 100.

The skirt construction 15 preferably joins the handle construction 16 by way of a skirt-to-handle junction construction 27, which skirt-to-handle junction construction 27 preferably comprises a disk-shaped exterior construction 28 and a concave inner construction 29. The concave inner construction 29 is coextensive with the inner concave surface 17 in radial adjacency to the threaded female structure 30 and/or threaded egg shell-piercing member 14.

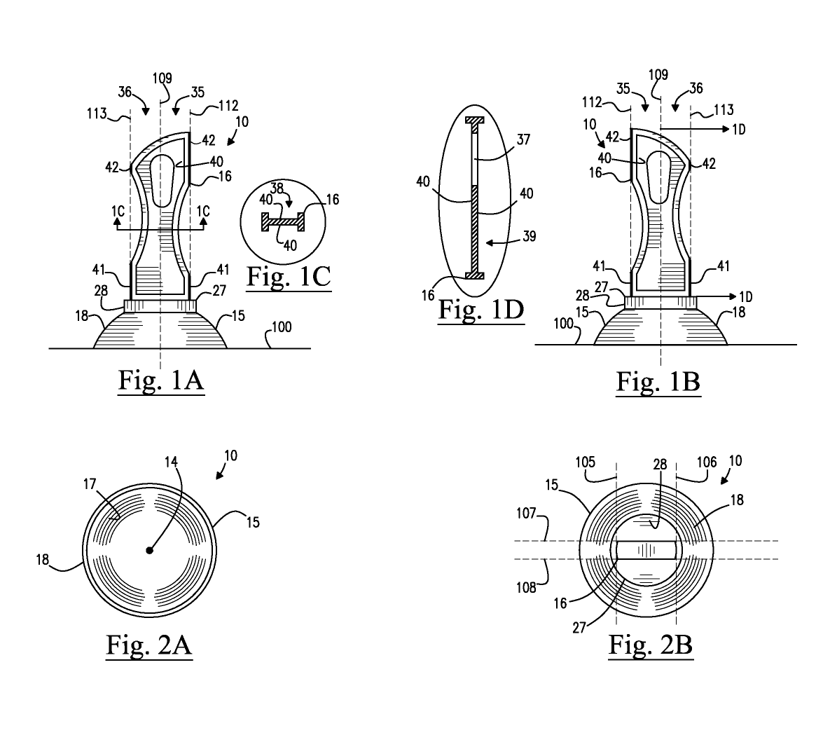

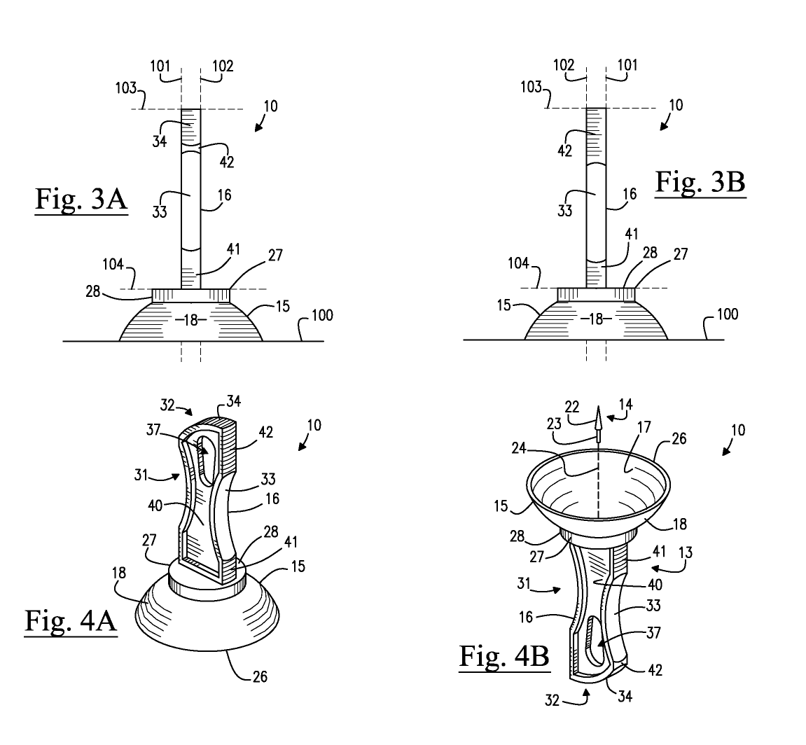

The handle construction 16 is preferably peripherally rectangular in a first dimension as generally depicted in FIGS. 3A and 3B between planes 101, 102, 103, and 104; and further preferably peripherally rectangular in a second dimension as depicted in FIG. 2B between plane 105, 106, 107, and 108. In the third dimension, however, the handle construction 16 is preferably peripherally (and roughly) hourglass-shaped. The hourglass-shaped third dimension is generally depicted in FIGS. 1A, 1B, and 5A through 5C.

The hourglass-shaped third dimension of the handle construction 16 preferably comprises a hand-gripping center region as at 31 and an end region as at 32. The hand-gripping center region 31 preferably comprises opposed concave handle surfaces as at 33, and the end region 32 preferably comprises a convex end surface as at 34. The hourglass-shaped third dimension further preferably comprises a frontal plane as at 109, which frontal plane 109 extends intermediate an anterior handle half 35 as at 35 and a posterior handle half as at 36. The anterior and posterior handle halves 35 and 36 are preferably non-symmetrical about the frontal plane 109 such that the anterior and posterior handle halves 35 and 36 may be structurally distinguished.

Given that the handle construction 13 preferably comprises an anterior handle half or portion 35 and a posterior handle half or portion 36, the reader should further note that the anterior handle portion 35 and the posterior handle portion 36 each preferably further comprises a planar proximal handle portion as at 41 and a planar distal handle portion as at 42. The proximal handle portions 41 and the distal handle portions 42 are preferably and respectively coplanar and parallel to one another as at planes 112 and 113.

The hourglass-shaped third dimension further preferably comprises an egg-shaped aperture as at 37 for further reducing material cost and providing certain means for hanging the egg shell-piercing device 10 via an aperture-engaging device (not specifically illustrated). The egg-shaped aperture 37 preferably comprises a major axis as at 110 and a minor axis as at 111. The frontal plane 109 preferably comprises or embraces the major axis 110 of the egg-shaped aperture 37.

The hourglass-shaped third dimension further preferably comprises a recessed material construction as at 40 in adjacency to the egg-shaped aperture 37. In this regard, the peripherally rectangular first and second dimensions each preferably comprise an I-shaped transverse cross-section as at 38 in FIG. 1C, and 39 in FIG. 1D, respectively. The recessed material construction 40 helps further reduce molding costs; increases or maintains handle strength; and speeds manufacturing times for the combination skirt-handle construction 13.

While the above descriptions contain much specificity, this specificity should not be construed as limitations on the scope of the invention, but rather as an exemplification of the invention. For example, the basic invention may be said to essentially teach or disclose a shell-piercing device for piercing a shell, which shell-piercing device essentially comprises a skirt-handle construction and a shell-piercing member.

The skirt-handle construction essentially comprises a skirt portion and a handle portion. The skirt portion has an inner concave surface for receiving a convex contour of a shell. The shell-piercing member is cooperably associated with the skirt-handle construction at the inner concave surface. The inner concave surface receives a select shell and the shell-piercing member pierces said select shell.

Accordingly, although the invention has been described by reference to a number of embodiments, it is not intended that the novel egg-poking or piercing apparatus be limited thereby, but that modifications thereof are intended to be included as falling within the broad scope and spirit of the foregoing disclosure, the following claims, and the appended drawings.

I claim:

1. An egg shell-piercing device, the egg shell piercing-device for piercing an egg shell, said egg shell piercing-device comprising:
a combination skirt-handle construction, the combination skirt-handle construction comprising an upper skirt construction and a lower handle construction, the skirt and handle constructions being integrally formed, the skirt construction having an inner concave surface, an outer convex surface, and a skirt axis, the inner concave surface for receiving a convex contour of an egg shell and comprising an inner surface depth and a threaded female structure; and
a pointed, shell-piercing member, the pointed, shell-piercing member comprising a lower pointed end and an upper threaded end, the upper threaded end being threadably connected to the combination skirt-handle construction via the threaded female structure and comprising a rigid material construction, the shell-piercing member comprising a member axis and a lower shell-piercing length, the member axis being coaxial with the skirt axis when the shell-piercing member is threadably connected to the combination skirt-handle construction, the inner surface depth being greater than the lower shell-piercing length, the inner concave surface for receiving a select egg shell and the shell-piercing member for piercing said select egg shell.

2. The egg shell-piercing device of claim 1 wherein the combination skirt-handle construction comprises a polymeric material construction and the shell-piercing member comprises a metallic material construction.

3. The egg shell piercing device of claim 1 wherein the skirt construction joins the handle construction via a skirt-to-handle junction construction, the skirt-to-handle junction construction comprising a disk-shaped exterior construction and a concave inner construction, the concave inner construction being coextensive with the inner concave surface.

4. The egg shell piercing device of claim 3 wherein the handle construction is peripherally rectangular in both a first dimension and a second dimension and peripherally hourglass-shaped in a third dimension.

5. The egg shell piercing device of claim 4 wherein the hourglass-shaped third dimension comprises a hand-gripping center region and an end region, the hand-gripping center region comprising opposed concave handle surfaces and the end region comprising a convex end surface.

6. The egg shell-piercing device of claim 5 wherein the hourglass-shaped third dimension comprises a frontal plane, the frontal plane extending intermediate an anterior handle half and a posterior handle half, the anterior and posterior handle halves being non-symmetrical about the frontal plane.

7. The egg shell-piercing device of claim 6 wherein the hourglass-shaped third dimension comprises an egg-shaped aperture, the egg-shaped aperture comprising a major axis and a minor axis, the frontal plane comprising the major axis of the egg-shaped aperture.

8. The egg shell-piercing device of claim 7 wherein the hourglass-shaped third dimension comprises a recessed material construction in adjacency to the egg-shaped aperture, the peripherally rectangular first and second dimensions thus each comprising an I-shaped transverse cross-section, the recessed material construction for reducing manufacturing cost, speeding manufacturing times, and maintaining handle strength.

9. The egg shell-piercing device of claim 5 wherein the handle construction comprises an anterior handle portion and a posterior handle portion, the anterior and posterior handle portions each comprising a planar proximal handle portion and a planar distal handle portion, the proximal and distal handle portions being respectively coplanar and parallel to one another.

10. The egg shell-piercing device of claim 3 wherein the skirt construction comprises a planar skirt rim, the planar skirt rim and inner surface depth for enabling the user to stand the egg shell-piercing device upon a planar support surface.

11. An egg shell-piercing device, the egg shell-piercing device for piercing an egg shell, said egg shell-piercing device comprising:
a combination skirt-handle construction, the combination skirt-handle construction comprising a skirt portion and a handle portion, the skirt portion having an inner concave surface and a skirt axis, the inner concave surface for receiving a convex contour of an egg shell and comprising an inner surface depth; and
a shell-piercing member, the shell-piercing member being connected to the combination skirt-handle construction at the inner concave surface, the shell-piercing member comprising a member axis and a shell-piercing length, the member axis being coaxial with the skirt axis when the shell-piercing member is connected to the combination skirt-handle construction, the inner surface depth being greater than the shell-piercing length, the inner concave surface for receiving a select egg shell and the shell-piercing member for piercing said select egg shell.

12. The egg shell-piercing device of claim 11 wherein the skirt portion joins the handle portion via a skirt-to-handle junction construction, the skirt-to-handle junction construction comprising a disk-shaped exterior construction and a concave inner construction, the concave inner construction being coextensive with the inner concave surface.

13. The egg shell-piercing device of claim 11 wherein the handle portion is peripherally rectangular in both a first dimension and a second dimension and peripherally hourglass-shaped in a third dimension.

14. The egg shell piercing device of claim 13 wherein the hourglass-shaped third dimension comprises a hand-gripping center region and an end region, the hand-gripping center region comprising opposed concave handle surfaces and the end region comprising a convex end surface.

15. The egg shell-piercing device of claim 13 wherein the hourglass-shaped third dimension comprises a frontal plane, the frontal plane extending intermediate an anterior handle half and a posterior handle half, the anterior and posterior handle halves being non-symmetrical about the frontal plane.

16. The egg shell-piercing device of claim 13 wherein the hourglass-shaped third dimension comprises an aperture, the aperture for reducing material cost and providing certain means for hanging the device via an aperture-engaging device.

17. The egg shell-piercing device of claim 13 wherein the hourglass-shaped third dimension comprises a recessed material construction, the peripherally rectangular first and second dimensions thus each comprising an I-shaped transverse cross-section, the recessed material construction for reducing manufacturing cost, speeding manufacturing times, and maintaining handle strength.

18. The egg shell-piercing device of claim 13 wherein the handle portion comprises an anterior handle portion and a posterior handle portion, the anterior and posterior handle portions each comprising a planar proximal handle portion and a planar distal handle portion, the proximal and distal handle portions being respectively coplanar and parallel to one another.

19. The egg shell-piercing device of claim 11 wherein the skirt portion comprises a planar skirt rim, the planar skirt rim and inner surface depth for enabling the user to stand the egg shell-piercing device upon a planar support surface.

20. A shell-piercing device, the shell-piercing device comprising:
a skirt-handle construction, the skirt-handle construction comprising a skirt portion and a handle portion, the skirt portion having an inner concave surface, the inner concave surface for receiving a convex contour of a shell; and
a shell-piercing member, the shell-piercing member being cooperably associated with the skirt-handle construction at the inner concave surface, the inner concave surface for receiving a select shell and the shell-piercing member for piercing said select shell.
